(19) United States
(12) Patent Application Publication
(10) Pub. No.: US 2009/0295865 A1
(43) Pub. Date: Dec. 3, 2009

(54) HEAD MOVING MECHANISM AND IMAGE FORMING APPARATUS

(75) Inventor: Nobuyuki Kamitani, Tokyo (JP)

Correspondence Address: SONNENSCHEIN NATH & ROSENTHAL LLP, P.O. BOX 061080, WACKER DRIVE STATION, WILLIS TOWER, CHICAGO, IL, 60606-1080, US

(73) Assignee: SONY CORPORATION, Tokyo (JP)

(21) Appl. No.: 12/472,449

(22) Filed: May 27, 2009

(30) Foreign Application Priority Data
May 29, 2008 (JP) 2008-140765

(51) Int. Cl. B41J 23/00

(52) U.S. Cl. 347/37

(57) ABSTRACT

A head moving mechanism includes a printhead configured to form an image and movable between a printing position where an image is formed, a standby position away from the printing position, and a retracted position across from the printing position relative to the standby position; a cam mechanism configured to move the printhead between the printing position and the standby position; and a rack-and-pinion mechanism configured to move the printhead between the standby position and the retracted position.

### BACKGROUND OF THE INVENTION

1. Field of the Invention

The present invention relates to head moving mechanisms each capable of moving a printhead between a printing position where an image is formed, a standby position where, for example, preparation for image formation is performed, and a retracted position where image formation is not performed, and also relates to image forming apparatuses. More specifically, the present invention relates to a technique in which the size of a head moving mechanism can be reduced without reducing the movement accuracy and the movement speed of a printhead.

2. Description of the Related Art

Common image forming apparatuses provided with printheads configured to form images include a printer, a copier, a facsimile, and the like. One of typical examples is a line thermal printer. The line thermal printer includes a thermal head, serving as a printhead, on which a plurality of heating elements, such as heating resistors, are arranged in a line. There are several types of thermal printers, including a dye-sublimation type, a thermal-wax-transfer type, and a thermosensitive type. In any type, the heating elements on the thermal head are selectively energized in accordance with gray-scale levels, and with thermal energy generated by this energization, an image is formed on recording paper of any kind.

In a dye-sublimation thermal printer, a thermal head is pressed against ink ribbon and recording paper that are conveyed to a platen, whereby an image is formed. Such a thermal head is configured to be capable of coming into contact with and moving away from the platen, and is controlled to move up and down in accordance with operations performed for image formation. Specifically, the thermal head moves between a printing position where an image is formed and a standby position where the thermal head stands by away from the printing position when, for example, preparation for image formation is performed. An example of such a configuration is disclosed in Japanese Unexamined Patent Application Publication No. 2006-1113.

To move the thermal head up and down, a cam mechanism in which a head holding member that is swingably supported by a shaft is moved by using a cam is typically employed. Since the length of such a movement stroke between the printing position and the standby position is only a few millimeters, the size of the cam is also small so as to be suitable for such a short movement stroke. In addition, the extent to which the thermal head is pressed can be precisely adjusted with ease by adjusting the shape of the cam. That is, in forming an image, the thermal head is moved up and down by a small, easy-to-adjust cam mechanism.

For the purpose of a maintenance operation of the thermal head or replacement of the ink ribbon, the thermal head is occasionally retracted farther away from the printing position beyond the standby position. Thus, the operability in the maintenance operation and replacement of the ink ribbon is improved, and various precision mechanisms provided inside the thermal printer and the heating elements provided on the thermal head are prevented from being contaminated and damaged.

As described above, the thermal head is moved not only between the printing position and the standby position, but also to a retracted position where the thermal head is held retracted. To move the thermal head between the standby position and the retracted position, a cam mechanism is also typically used. In such a case, a small-sized cam configured to move the thermal head up and down and a large-sized cam configured to retract the thermal head are provided so as to operate in conjunction with each other, or the profile of a small-sized cam is incorporated into the profile of a large-sized cam.

### SUMMARY OF THE INVENTION

In the above-described case, however, the movement stroke to the retracted position is as long as several tens of millimeters at the minimum. This makes the size of the large cam, provided for retracting movement, many times as large as the size of the small cam, provided for up-and-down movement. Therefore, if a head moving mechanism only employs cam mechanisms, the size of the head moving mechanism will problematically increase with a space accommodating such a large cam and a driving mechanism capable of rotating the large cam. In addition, the speed of retracting movement using a cam mechanism is low. In contrast, if a head moving mechanism is constituted by crank mechanisms and the like, instead of cam mechanisms, the movement accuracy will be deteriorated. This may cause another problem in moving the thermal head up and down.

In light of the above, it is desirable that the present invention provide a technique of reducing the size of a head moving mechanism without reducing the movement accuracy and the movement speed of a printhead, such as a thermal head.

According to a first embodiment of the present invention, a head moving mechanism includes a printhead configured to form an image and movable between a printing position where an image is formed, a standby position away from the printing position, and a retracted position across from the printing position relative to the standby position; a cam mechanism configured to move the printhead between the printing position and the standby position; and a rack-and-pinion mechanism configured to move the printhead between the standby position and the retracted position.

According to a second embodiment of the present invention, an image forming apparatus includes the head moving mechanism according to the first embodiment.

In the embodiments described above, the movement of the printhead between the printing position and the standby position is realized by the cam mechanism, whereas the movement of the printhead between the standby position and the retracted position is realized by the rack-and-pinion mechanism. Specifically, a short-stroke up-and-down movement of the printhead, in which the movement accuracy takes priority, is realized by the cam mechanism, which is superior in movement accuracy, whereas a long-stroke retracting movement of the printhead, in which the movement speed takes priority, is realized by the rack-and-pinion mechanism, not by a cam mechanism including a large cam.

In such a configuration, the space occupied by the foregoing mechanisms are minimized, and the printhead can be moved by using an appropriate one of the mechanisms. Consequently, the size of the head moving mechanism can be reduced without reducing the movement accuracy and the movement speed of the printhead.

### BRIEF DESCRIPTION OF THE DRAWINGS

FIG. 1 is a side view showing the basic configuration of a thermal printer according to an embodiment of the present invention;

FIGS. 2A to 2C are side views of a thermal head shown in FIG. 1 at respective positions;

FIG. 3 is a side view of a head moving mechanism according to the embodiment, with the thermal head at a standby position;

FIG. 4 is a side view of the head moving mechanism according to the embodiment, with the thermal head at a printing position; and

FIG. 5 is a side view of the head moving mechanism according to the embodiment, with the thermal head at a retracted position.

### DESCRIPTION OF THE PREFERRED EMBODIMENTS

An embodiment of the present invention will now be described with reference to the accompanying drawings.

The embodiment given below will be described taking a dye-sublimation thermal printer 1 as an example of the image forming apparatus according to the present invention, in which a mechanism corresponding to the head moving mechanism according to the present invention is included.

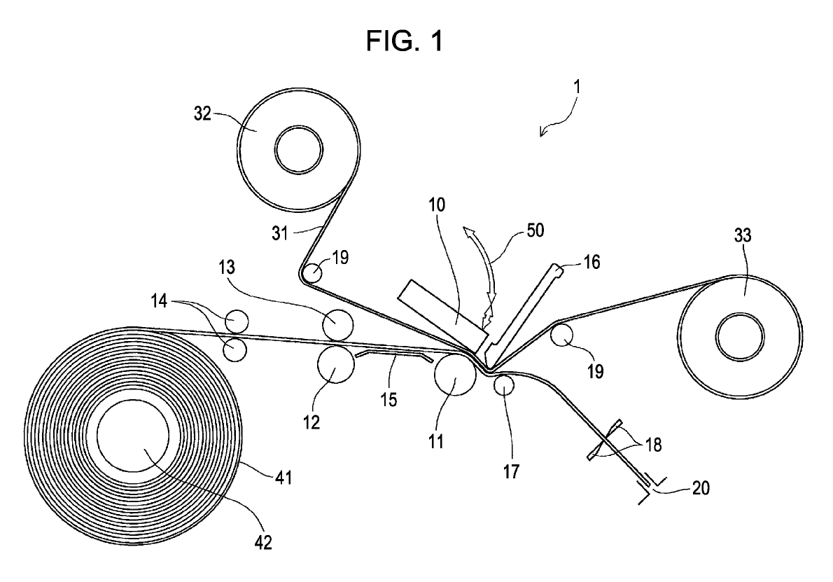

FIG. 1 is a side view showing the basic configuration of the thermal printer 1 according to the embodiment.

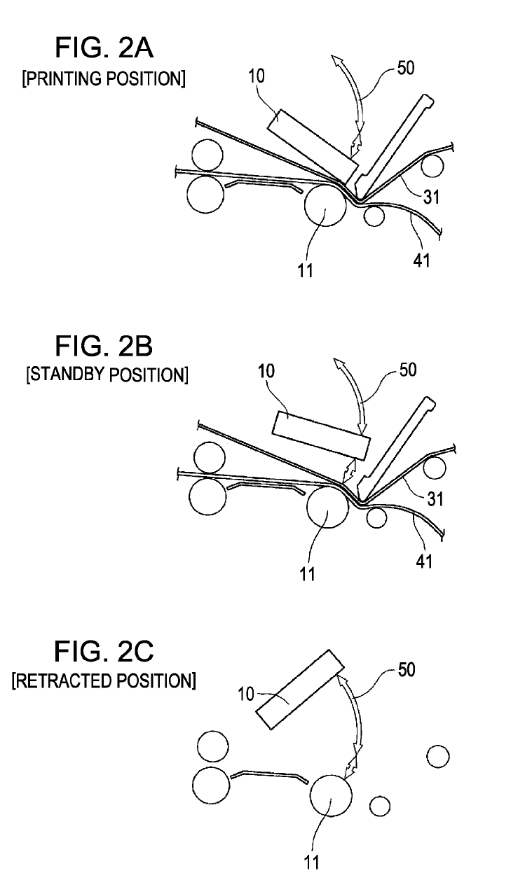

FIGS. 2A to 2C are side views of a thermal head 10 (corresponding to the print head according to the present invention) shown in FIG. 1, at a printing position, a standby position, and a retracted position, respectively.

Referring to FIGS. 1 to 2C, the thermal printer 1 according to the embodiment includes the thermal head 10, on which a plurality of heating elements (heating resistors, for example) are arranged in a line. With thermal energy generated when the heating elements on the thermal head 10 are energized, sublimable dye applied to ink ribbon 31 is sublimed and transferred onto recording paper 41, whereby an image is formed.

Referring to FIG. 1, the recording paper 41 is provided in a form of a roll and is held by a paper holder 42. In a state where the paper holder 42 is placed at a predetermined position in the thermal printer 1, the recording paper 41 on the paper holder 42 is appropriately drawn out by a pair of feeding rollers 14.

The recording paper 41 that has been drawn out is conveyed by a capstan roller 12 (a driving roller) and a pinch roller 13 (a driven roller). Specifically, the recording paper 41 is nipped between the capstan roller 12 and the pinch roller 13 and is guided toward the thermal head 10 with the rotation of the capstan roller 12. Since the recording paper 41 is further guided by a conveyance guide 15, the recording paper 41 can be prevented from having the leading end thereof knock against a platen roller 11 (corresponding to the platen according to the present invention) and therefore folded, for example. Accordingly, the recording paper 41 is assuredly conveyed to a position between the thermal head 10 and the platen roller 11. The platen roller 11 may alternatively be a platen having any shape (a plate-like shape, for example) other than a roller shape.

The ink ribbon 31, which is sectioned into respective portions of an yellow (Y) ink, a magenta (M) ink, a cyan (C) ink, and a transparent laminating ink (L), is housed in a ribbon cassette (not shown). The ink ribbon 31 is reeled off from a supply reel 32 provided in the ribbon cassette, is guided by two guide rollers 19 so as to be conveyed over the platen roller 11 and the recording paper 41, and is reeled in by a collecting reel 33 provided in the ribbon cassette, in accordance with gray-scale data that has undergone color conversion processing.

When an image is formed by the thermal printer 1 configured as described above, the thermal head 10 that has been positioned away from the platen roller 11 for the purpose of preparatory operations or the like prior to image formation is lowered and is pressed against the platen roller 11, as shown in FIGS. 1 and 2A. Specifically, the thermal head 10 is moved by a head moving mechanism 50 from the standby position, shown in FIG. 2B, where the thermal head 10 is held away from the platen roller 11, to the printing position, shown in FIG. 2A. Thus, the thermal head 10 is pressed against the platen roller 11 with the ink ribbon 31 and the recording paper 41 nipped therebetween.

In this state, when the capstan roller 12, shown in FIG. 1, is driven to rotate clockwise and the ink ribbon 31 is reeled in by the collecting reel 33, the recording paper 41 and the ink ribbon 31 are conveyed in a feeding direction (the rightward direction in FIG. 1) from a printing start position to a printing end position. With an input of gray-scale data to the thermal head 10 during the foregoing conveyance operation, the heating elements arranged in the width direction of the recording paper 41 are selectively energized and driven. This causes the thermal head 10 to generate thermal energy. With the thermal energy, the yellow (Y) ink (a first ink) on the ink ribbon 31 is sublimed and is transferred onto the recording paper 41.

The ink ribbon 31, which has had the yellow (Y) ink transferred onto the recording paper 41 by being nipped together with the recording paper 41 between the thermal head 10 and the platen roller 11, is subsequently separated from the recording paper 41 by a ribbon separating member 16 provided on the downstream side in the feeding direction with respect to the thermal head 10 and the platen roller 11. Specifically, the ink ribbon 31 that has firmly adhered to the recording paper 41 after the ink transfer because of the pressing force and heat applied by the thermal head 10 is separated from the recording paper 41 by bringing the tip of the ribbon separating member 16, having a blade-like shape, into contact with the back surface of the ink ribbon 31 such that the ink ribbon 31 is bent at a predetermined angle with respect to the feeding direction.

After the transfer of the yellow (Y) ink as described above, a preparatory operation for transfer of the magenta (M) ink is performed. In color printing, ink transfer is performed individually for the colors of yellow (Y), magenta (M), and cyan (C). Therefore, after every ink transfer, the thermal head 10 that has been lowered is lifted back to the standby position, shown in FIG. 2B, away from the printing position, shown in FIG. 2A, whereby the recording paper 41 is released from the pressing force applied by the thermal head 10. Subsequently, the capstan roller 12 is driven to rotate in the reverse (counterclockwise) direction, whereby the recording paper 41 is conveyed in a return direction (the leftward direction in FIG. 1) back to the printing start position.

Next, as in the case of the transfer of the yellow (Y) ink, transfer of the magenta (M) ink, a second ink, is performed. Specifically, the thermal head 10 is moved by the head moving mechanism 50 to the printing position, whereby the ink ribbon 31 and the recording paper 41 is nipped between the thermal head 10 and the platen roller 11. Then, while the recording paper 41 is conveyed in the feeding direction toward the printing end position, transfer of the magenta (M) ink, provided on the ink ribbon 31, is performed. After the transfer of the magenta (M) ink, transfer of the cyan (C) ink, a third ink, is performed in the same manner. Further, to protect the image resulting from the transfers of the color inks (Y, M, and C) from ultraviolet rays and the like and thus to improve the radiation-proof characteristic of the image, transfer of the laminating ink (L) is lastly performed.

After the transfer of the laminating ink (L), the last ink, the recording paper 41 having the color image printed thereon is bent by a decurl roller 17, shown in FIG. 1, in a direction (the upward direction in FIG. 1) opposite to the direction of the curl in the recording paper 41 (the direction toward the inside of the roll) so that the curl is flattened. Subsequently, the recording paper 41 is cut by a cutter 18 into a piece having a predetermined length, and is output through an output port 20.

During the period from the start of the transfer of the yellow (Y) ink, the first ink, until the end of the transfer of the laminating ink (L), the fourth (last) ink, the thermal head 10 moved by the head moving mechanism 50 reciprocates four times in total between the printing position, shown in FIG. 2A, where an image is formed, and the standby position, shown in FIG. 2B, away from the printing position,. The movement stroke between the two positions is as short as several millimeters at the maximum. Considering that the platen roller 11 is pressed while the transfer is performed, the head moving mechanism 50 is desired to operate with high movement accuracy.

For the purpose of replacement of the ink ribbon 31 that has been used up after repeated transfers or a maintenance operation of the thermal head 10, the thermal head 10 is moved by the head moving mechanism 50 farther away from the printing position beyond the standby position. Specifically, to improve the operability in the maintenance operation and ink ribbon replacement and to prevent various precision mechanisms provided inside the thermal printer 1 and the heating elements provided on the thermal head 10 from being contaminated and damaged, the thermal head 10 is moved to the retracted position, shown in FIG. 2C, across from the printing position relative to the standby position. The movement stroke between the standby position and the retracted position is as long as several tens of millimeters at the minimum. Therefore, the head moving mechanism 50 is desired to be small and to move quickly.

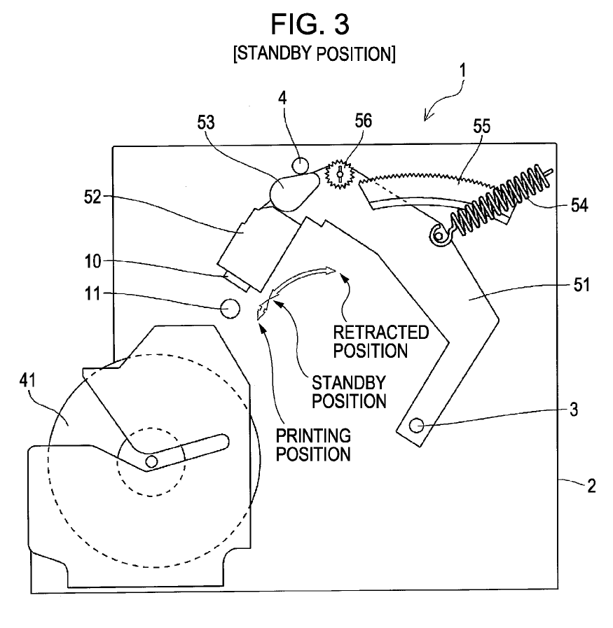

FIGS. 3 to 5 are side views of the head moving mechanism 50 according to the embodiment.

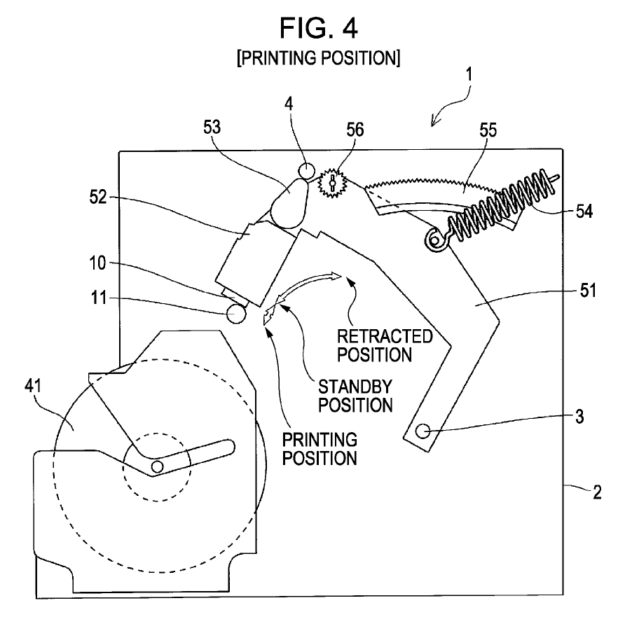

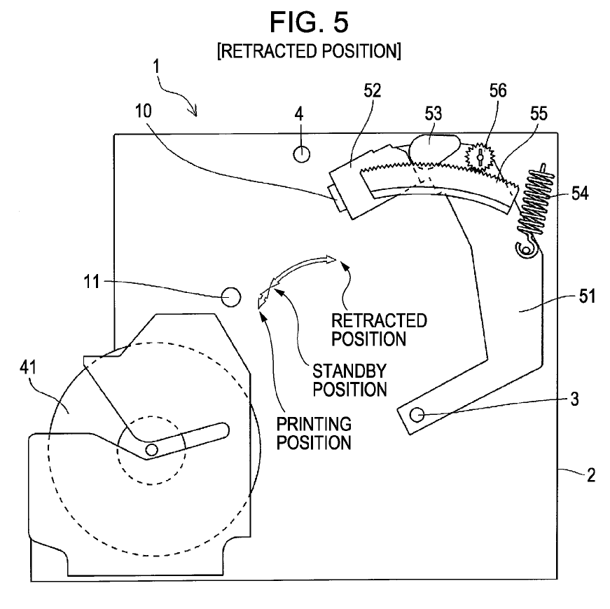

FIG. 3 shows a state where the thermal head 10 is at the standby position. FIG. 4 shows a state where the thermal head 10 is at the printing position. FIG. 5 shows a state where the thermal head 10 is at the retracted position.

At the standby position shown in FIG. 3, the thermal head 10 is held several millimeters away from the platen roller 11 so that an image forming operation can be started immediately upon input of a printing command. The thermal head 10 is movable with the aid of the head moving mechanism 50.

The head moving mechanism 50 includes a swing arm 51, a head holder 52, an eccentric cam 53 (corresponding to the cam mechanism according to the present invention), a tension spring 54, and a set of a rack 55 and a pinion 56 (corresponding to the rack-and-pinion mechanism according to the present invention). The thermal head 10 is mounted on the head holder 52 provided at the tip of the swing arm 51.

The swing arm 51 is made of sheet metal or the like. The base of the swing arm 51 is rotatably supported by a body frame 2 of the thermal printer 1. Specifically, the base of the swing arm 51 is supported by a rotation support shaft 3 provided on the body frame 2. In such a configuration, the swing arm 51 swings about the rotation support shaft 3 such that the tip of the swing arm 51 having the head holder 52 moves along an arc-shaped path. Thus, the thermal head 10 can move along with the swing arm 51.

The head holder 52 provided on the swing arm 51 is secured to the swing arm 51 such that the surface thereof on which the thermal head 10 is mounted is substantially parallel to the platen roller 11. Therefore, when the swing arm 51 swings about the rotation support shaft 3 with the tip thereof moving along the arc-shaped path and thus the thermal head 10 is lowered, the heating elements provided on the thermal head 10 face the surface of the platen roller 11.

To swing the swing arm 51 and lower the thermal head 10 toward the platen roller 11, the swing arm 51 has near the tip thereof the eccentric cam 53. Meanwhile, the swing arm 51 is continuously urged by the tension spring 54 in such a direction as to be pulled up, i.e., in a direction in which the thermal head 10 is lifted away from the platen roller 11. Therefore, with the urging force of the tension spring 54, the eccentric cam 53 is in contact with a contact pin 4 projecting from the body frame 2.

At the standby position shown in FIG. 3, the eccentric cam 53 is in contact in a predetermined eccentric position with the contact pin 4. When the eccentric cam 53 is in this eccentric position, the thermal head 10 is prevented from being lowered while the swing arm 51 is pulled up by the urging force of the tension spring 54. Thus, the thermal head 10 is held at the standby position several millimeters away from the platen roller 11.

The eccentric cam 53 is rotated to a controlled angle with a driving force transmitted via a belt (not shown) from a driving motor (not shown) secured to the swing arm 51. When a printing command is input to the thermal printer 1, the driving motor rotates the eccentric cam 53 to a predetermined angle, whereby the contact position of the eccentric cam 53 with respect to the contact pin 4 changes. As a result, the swing arm 51 is pushed down against the urging force of the tension spring 54 and swings about the rotation support shaft 3, whereby the thermal head 10 is lowered.

FIG. 4 shows the state where the thermal head 10 has been lowered to the printing position. In this state, the eccentric cam 53 pushing down the swing arm 51 causes the thermal head 10 to be pressed against the platen roller 11. Since the thermal head 10 can be lowered with high movement accuracy with the rotation of the eccentric cam 53 to a controlled angle, the pressing force applied to the platen roller 11 is optimized for transfers of the inks (Y, M, C, and L) on the ink ribbon 31 (refer to FIG. 1). At the printing position, the ink ribbon 31 and the recording paper 41, although not shown in FIG. 4, are nipped between the thermal head 10 and the platen roller 11.

Since the length of the movement stroke of the thermal head 10 from the standby position shown in FIG. 3 to the printing position shown in FIG. 4 is about several millimeters at the maximum, the eccentric cam 53 is provided in a small size, suitably for such a short movement stroke. After the transfers of the inks (Y, M, C, and L), the eccentric cam 53 is controlled to rotate in the reverse direction so that the original contact position of the eccentric cam 53 with respect to the contact pin 4 is regained. In response to this, the thermal head 10 is lifted up with the urging force of the tension spring 54, whereby the thermal head 10 that has been at the printing position shown in FIG. 4 returns to the standby position shown in FIG. 3.

Thus, the thermal head 10 can move with the aid of the eccentric cam 53, i.e., the cam mechanism, of the head moving mechanism 50 between the printing position, shown in FIG. 4, where an image is formed, and the standby position, shown in FIG. 3, away from the printing position. At the printing position, the eccentric cam 53 causes the thermal head 10 to be pressed against the platen roller 11 with an appropriate force, and the inks (Y, M, C, and L) on the ink ribbon 31 (refer to FIG. 1) subjected to the thermal energy generated by the thermal head 10 are transferred onto the recording paper 41, whereby an image is formed.

When image formation is finished and no more images are to be formed, specifically, when the ink ribbon 31 is to be replaced with new one or when the power is to be shut down, the thermal head 10 is moved to the retracted position shown in FIG. 5 so that the operability in the maintenance operation can be improved and various mechanisms in the thermal printer 1 can be protected.

The retracted position shown in FIG. 5 is defined at a position across from the printing position shown in FIG. 4 relative to the standby position shown in FIG. 3. At the retracted position, the thermal head 10 is held farther away from the platen roller 11 beyond the standby position. Accordingly, the length of the movement stroke of the thermal head 10 from the standby position shown in FIG. 3 to the retracted position shown in FIG. 5 is as long as several tens of millimeters at the minimum.

Considering such circumstances, the head moving mechanism 50 includes, in addition to the cam mechanism, i.e., the eccentric cam 53, a rack-and-pinion mechanism, i.e., the rack 55 and the pinion 56. Specifically, the rack 55 is provided on the body frame 2, and the pinion 56 meshes with the rack 55. The rack 55 has an arc shape corresponding to the arc-shaped path along which the tip of the swing arm 51 moves.

The pinion 56 is provided near the tip of the swing arm 51 and adjacent to the eccentric cam 53. The pinion 56 is driven with a driving force transmitted from a driving motor (not shown), different from the one provided for the eccentric cam 53, and is controlled to rotate in the normal or reverse direction in accordance with the operation of the thermal printer 1. When the pinion 56 is rotated clockwise, the pinion 56 moves rightward along the rack 55. This movement causes the swing arm 51 at the position shown in FIG. 3 to be further pulled up. As a result, the thermal head 10 is moved from the standby position shown in FIG. 3 to the retracted position shown in FIG. 5. If the length of the rack 55 is increased, the range in which the swing arm 51 swings can be widened. In that case, the thermal head 10 can be retracted farther (to a position farther away from the standby position).

The movement of the thermal head 10 from the standby position shown in FIG. 3 to the retracted position shown in FIG. 5 is desired to be made smoothly. Specifically, it is desired to realize the movement of the swing arm 51 with the rotation of the eccentric cam 53 and the movement of the swing arm 51 with the meshing between the rack 55 and the pinion 56 in series. In this respect, when the thermal head 10 is moved from the standby position to the retracted position, the eccentric cam 53 is controlled to rotate in such a manner as not to come into contact with the contact pin 4. Accordingly, the swing arm 51 is pulled by the urging force of the tension spring 54 and is retracted farther from the standby position, whereby the pinion 56 meshes with the rack 55.

In this fashion, the thermal head 10 can be moved by the rack 55 and the pinion 56, i.e., the rack-and-pinion mechanism, included in the head moving mechanism 50 between the standby position, shown in FIG. 3, away from the printing position, shown in FIG. 4, and the retracted position, shown in FIG. 5, across from the printing position relative to the standby position. To summarize, the thermal head 10 is moved between the printing position and the standby position by the eccentric cam 53 (the cam mechanism), and between the standby position and the retracted position by the rack 55 and the pinion 56 (the rack-and-pinion mechanism). In such a configuration, the stroke of the thermal head 10 moved by the rack 55 and the pinion 56 (the distance between the standby position and the retracted position) is set to be longer than the stroke of the thermal head 10 moved by the eccentric cam 53 (the distance between the printing position and the standby position).

Accordingly, when the maintenance operation or replacement of the ink ribbon 31 is performed and therefore the thermal head 10 is desired to be positioned at a long distance from the platen roller 11, the thermal head 10 is moved by the longer stroke to the retracted position. As a result, operability in the maintenance operation and replacement of the ink ribbon 31 is improved, and various precision mechanisms provided inside the thermal printer 1 and the heating elements provided on the thermal head 10 are prevented from being contaminated and damaged.

The short-stroke movement of the thermal head 10 between the printing position and the standby position, in which the movement accuracy takes priority, is realized by the eccentric cam 53 (the cam mechanism), whereas the long-stroke movement of the thermal head 10 between the standby position and the retracted position, in which the movement speed takes priority, is realized by the rack 55 and the pinion 56 (the rack-and-pinion mechanism). In the head moving mechanism 50 having such a configuration, the eccentric cam 53 and the set of the rack 55 and the pinion 56 are arranged at respectively appropriate positions. Therefore, desired movement accuracy and movement speed can be obtained with the foregoing mechanisms provided in the minimum sizes and arrangement in the thermal printer 1. Thus, the size, weight, and manufacturing cost of the head moving mechanism 50 can be reduced without reducing the accuracy and speed of the movement to each position.

The printing position, the standby position, and the retracted position are all defined in a specific arc-shaped path, and the rack 55 is provided on the body frame 2 and extends along a portion of the arc-shaped path between the standby position and the retracted position. This contributes to a simple configuration in which the swing arm 51 is only supported by the rotation support shaft 3. Thus, the thermal head 10 can be moved with high accuracy only with the rotations of the eccentric cam 53 and the pinion 56.

The present invention is not limited to the embodiment that has been described above, and various modifications can be made thereto. Exemplary modifications are provided below.

(1) Although the embodiment concerns the head moving mechanism 50 configured to move the thermal head 10 of the thermal printer 1, the present invention is not limited thereto and may alternatively be applied to any other mechanisms that move printheads of various apparatuses such as a printer, a copier, and a facsimile.

(2) Although the embodiment concerns the case where the rack 55 and the pinion 56, corresponding to the rack-and-pinion mechanism, are provided on the body frame 2 and the swing arm 51, respectively, the present invention is not limited to such a configuration, and any other arrangement suitable for the thermal printer 1 is also acceptable.

The present application contains subject matter related to that disclosed in Japanese Priority Patent Application JP 2008-140765 filed in the Japan Patent Office on May 29, 2008, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A head moving mechanism comprising:
a printhead configured to form an image and movable between a printing position where an image is formed, a standby position away from the printing position, and a retracted position across from the printing position relative to the standby position;
a cam mechanism configured to move the printhead between the printing position and the standby position; and
a rack-and-pinion mechanism configured to move the printhead between the standby position and the retracted position.

2. The head moving mechanism according to claim 1, further comprising:
a platen facing the printhead,
wherein the cam mechanism causes the printhead at the printing position to be pressed against the platen.

3. The head moving mechanism according to claim 1,
wherein the printing position, the standby position, and the retracted position are defined in an arc-shaped path, and
wherein a rack included in the rack-and-pinion mechanism extends along a portion of the arc-shaped path between the standby position and the retracted position.

4. The head moving mechanism according to claim 1, wherein a length of movement of the printhead realized by the rack-and-pinion mechanism is larger than a length of movement of the printhead realized by the cam mechanism.

5. An image forming apparatus comprising:
a printhead configured to form an image and movable between a printing position where an image is formed, a standby position away from the printing position, and a retracted position across from the printing position relative to the standby position;
a cam mechanism configured to move the printhead between the printing position and the standby position; and
a rack-and-pinion mechanism configured to move the printhead between the standby position and the retracted position.
